(19) United States
(12) Patent Application Publication
(10) Pub. No.: US 2012/0309617 A1
(43) Pub. Date: Dec. 6, 2012

(54) Method of Production of Photocatalytic Powder Comprising Titanium Dioxide and Manganese Dioxide Active Under Ultraviolet and Visible Light

(75) Inventors: George Kiriakidis, Heraklion - Crete (GR); Vassilis Binas, Heraklion - Crete (GR); Valentin Tudose, Heraklion - Crete (GR)

(73) Assignee: Foundation for Research and Technology - Hellas / Forth, Heraklion-Crete (GR)

(21) Appl. No.: 13/519,999

(22) PCT Filed: Dec. 29, 2010
(86) PCT No.: PCT/EP2010/070872

§ 371 Date: Aug. 20, 2012

(30) Foreign Application Priority Data
Dec. 30, 2009 (GR) 20090100724

(51) Int. Cl. B01J 23/34

(52) U.S. Cl. 502/324

(57) ABSTRACT

A method of production of photocatalytic material to be used under UV and visible light. The photocatalyst is obtained by precipitating titanium dioxide on a sol of manganese dioxide. The method includes providing a mixture of a) hydrated manganese dioxide sol, b) titanium solution and c) NH₃ solution, and, the processing of the above. The photocatalyst produced with the method of the invention includes titanium and manganese with the atomic ratio Mn:Ti varying between 0.01:100 and 33:100. The manganese acts both as a dopant and as a photosensitizer. The photocatalyst is active under both UV and visible light and is able to decompose organic and inorganic pollutants. In general the photocatalyst can be used as obtained or embedded in a matrix (e.g. concrete, cement, mortar, stucco, paint etc) or immobilized on or in a solid surface/body. The photocatalyst can be further used for air or water de-pollution.

The present invention relates to a method of production of photocatalytic material, and, a photocatalytic material to be used under Ultra Violet (UV) and visible light. The invention addresses also photocatalytic redox reactions produced by UV and visible light.

TiO₂ is considered to be one the most effective and environmentally friendly photocatalyst due to its high chemical stability, and it is extensively used for the photodegradation of various pollutants both in liquid and gas phases (see for example EP-1 504 816 and US A 2002147108).

The photocatalysis based on semiconductor materials has a simple mechanism involving a few stages. When light, with energy at least equal with the bandgap, is absorbed by a semiconductor a number of electrons equal with the number of absorbed photons undergo a transition from the valence band to the conduction band leaving holes behind. Excited electrons in the conduction band and positive holes in the valence band are mobile; they migrate towards the surface becoming available for charge transfer and are thus capable to initiate surface chemical reactions, usually by the production of highly oxidative hydroxyl and superoxide radicals. Therefore, the photocatalytic activity will be depending on the type of the applied light source, the absorption properties in the specific semiconductor, the electron-hole recombination rate as well as the oxidation and reduction rates at the surface of the material. The bandgap of pure TiO₂ based photocatalytic materials is larger than 3 eV which is energetically equivalent to photons in the UV region of the spectrum. In order to make a visible light photocatalyst doping or photosensitizing can be used.

The object of the invention is to introduce a photocatalytic material and a method to produce such a material with relatively high photocatalytic activity under UV and visible light exposure, either natural or artificial.

The photocatalyst is obtained by precipitating titanium dioxide on a sol of manganese dioxide. The method of the invention comprises the steps of providing a mixture including a) hydrated manganese dioxide sol, b) titanium solution and c) NH₃ solution, and, the processing of the above.

The photocatalyst produced with the method of the present invention includes titanium and manganese. The manganese acts both as a dopant and as a photosensitizer. The photocatalyst is active under both UV and visible light and is able to decompose organic and inorganic pollutants. For example the photocatalyst may be used for the degradation of Volatile Organic Compounds (VOCs) such as acetaldehyde (CH₃CHO), formaldehyde (CH₂O), benzene, toluene etc and volatile inorganic compounds such as NOₓ, CO₂ under both, UV and visible light. In general the photocatalyst can be used as obtained or embedded in a matrix (i.e. concrete, cement, mortar, stucco, paint etc) or immobilized on or in a solid surface/body. The photocatalyst can be further used for air or water de-pollution.

Preferably the titanium solution used as precursor for the photocatalyst is an aqua solution of titanium oxysulfate.

The pH of the mixture of hydrated manganese dioxide sol, titanium solution and NH₃ solution may be between 6 and 8, and preferably 7.

The mixture of hydrated manganese dioxide sol, titanium solution and NH₃ solution is processed to obtain a powder including titanium dioxide and manganese dioxide. The powder thus obtained may be annealed at a temperature between 600° C. to 900° C., and preferably at a temperature around 700° C. Further the powder may be filtered and washed with distilled water until is free of sulfate and ammonium ions, yielding a brownish—grey powder. Before the annealing, the powder may be processed by grinding or milling to refine its particles.

An embodiment of the method includes the following steps: provide a colloidal solution containing hydrated manganese dioxide sol and titanium solution; stir the colloidal solution; add NH₃ solution to obtain a gel; mature the gel by stirring; separate the gel using a centrifuge or by filtering to obtain powder; wash the powder; dry the gel to obtain a dried product; grind or mill the dried product until is broken into a fine powder; and anneal the fine powder.

The photocatalyst obtained by the method according to the invention may have a predominant anatase crystalline structure, with particles having a size between 1 nm and 100 nm, mostly around 20 nm. Further, the photocatalyst may consist of powder including titanium dioxide and manganese dioxide formulations with the atomic ratio Mn:Ti varying between 0.01:100 and 33:100

The photocatalytic material according to the invention has a particular structure. The material is comprised of titanium dioxide and manganese dioxide and is obtained by a method involving the precipitation of titanium oxide on a sol of manganese dioxide. This photocatalytic material is suitable for air and water de-pollution and all other applications of photocatalysts in powder form.

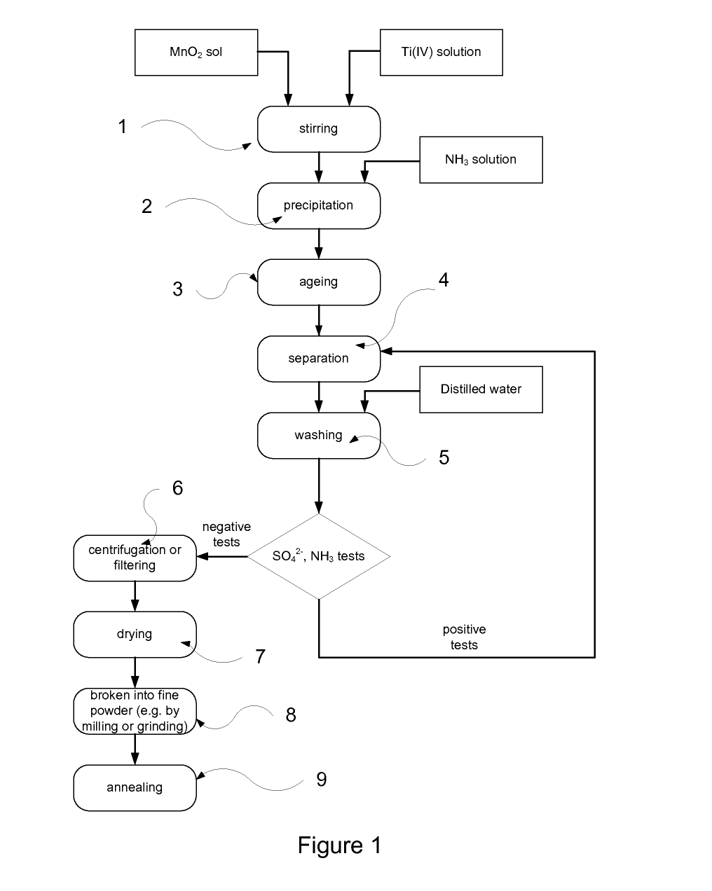

An embodiment of the invention is described with reference to FIGS. 1 to 6, whereby:

FIG. 1 illustrates the method of manufacturing steps for a photocatalytic material according to the invention,

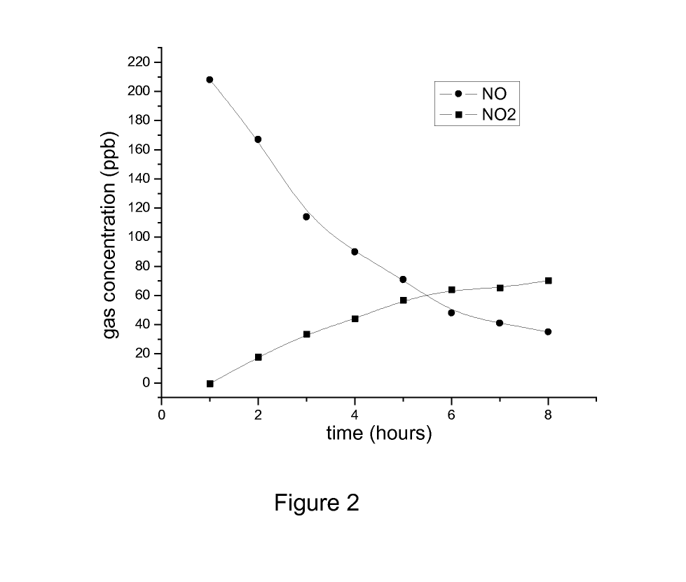

FIG. 2 shows the NO oxidation to NO₂ in the presence of photocatalyst under visible light exposure;

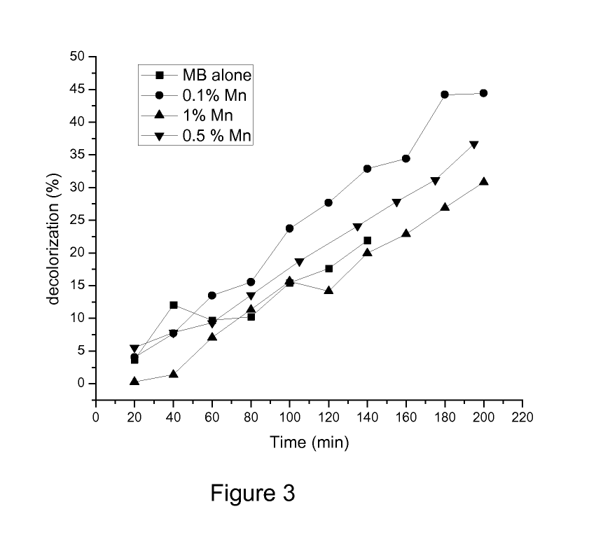

FIG. 3 shows the degradation of methylene blue in aqueous solution in the presence of photocatalyst under visible light exposure;

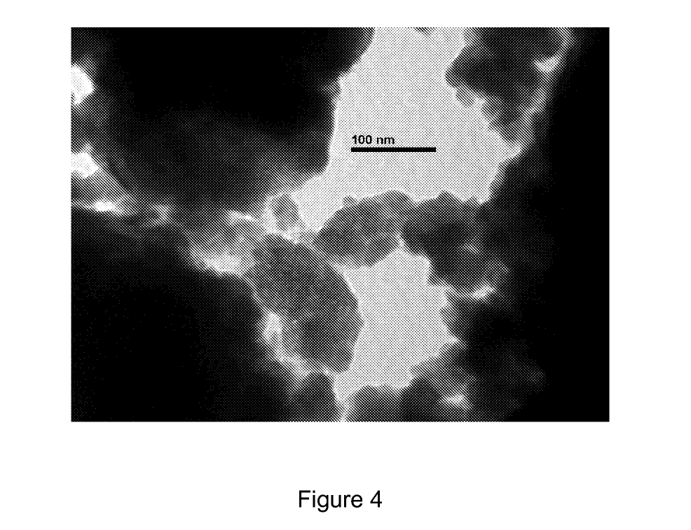

FIG. 4 shows a Transmission Electron Microscope image of the 1% MnO₂—TiO₂ with particles having a size between 1 nm and 100 nm; and

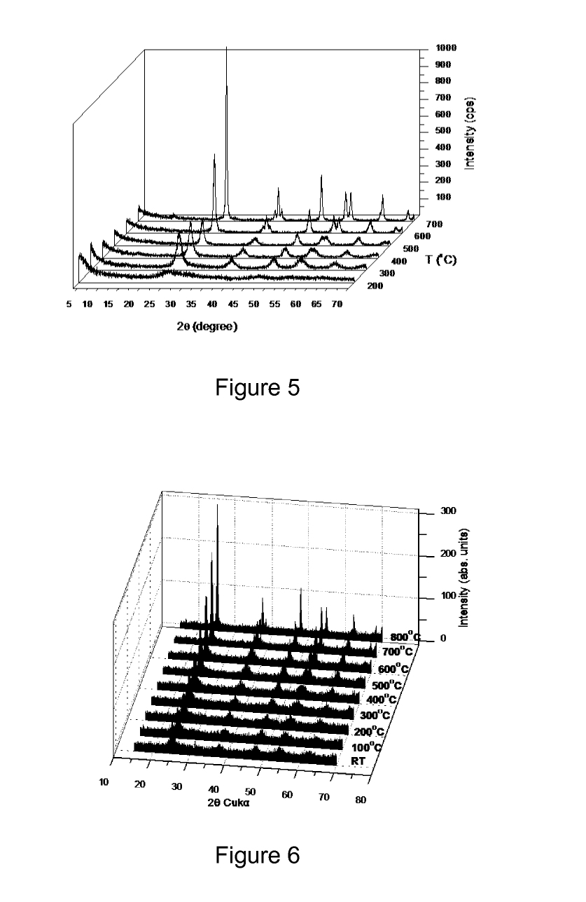

FIG. 5 and FIG. 6 show powder X-ray Diffraction (XRD) patterns of the anatase phase formation of 0.1% MnO₂ @ TiO₂ in different calcinations temperatures (Room Temperature (RT) −800° C.).

The photocatalyst material, which is a manganese dioxide-titanium dioxide composite, was prepared by a modified sol gel method. In this method the hydrated titanium dioxide gel was precipitated on a hydrated manganese dioxide sol. A photocatalyst, according to the invention, may be synthesized following the method steps described below and illustrated in FIG. 1. Different precursors such as titanium (IV) tetraisopropoxide, i.e. Ti{OCH(CH₃)₂}₄, and titanium(IV) oxysulfate, i.e. TiOSO₄xH₂O, may be employed for the production of an inventive photocatalyst material. In both cases, i.e. regardless the use of either titanium (IV) tetraisopropoxide or titanium (IV) oxysulfate as precursor, the photocatalytic material can be obtained with the same physical properties, the same structure and almost the same photocatalytic activity based on the synthesis involved. However, the titanium(IV) tetraisopropoxide is expensive and the synthesis requires organic solvents which increase the price of the final product; also the synthesis is harder to scale up, in contrast with the titanium(IV) oxysulfate (TiOSO₄) precursor. The TiOSO₄ precursor yields a less pure product, but this is overcome by thoroughly washing the product with water in order to leach all the soluble impurities.

The method to produce a photocatalyst that is illustrated in FIG. 1 includes the following steps:
provide a colloidal solution containing hydrated manganese dioxide sol and titanium solution,
stir the colloidal solution (1) at room temperature for a period between 24 to 68 hours, preferably around 48 hours,
add NH₃ solution to obtain a gel with pH between 6 and 8,
ageing the gel by stirring (3) for a period between 24 to 68 hours, preferably around 48 hours,
separate the gel using a centrifuge or by filtering to obtain powder,
wash (5) the powder with distilled water until is free of sulfate and ammonium,
filter or centrifuge the powder (6),
dry (7) the powder to obtain fine powder,
break the powder into a fine powder (8) by grinding or milling, and
anneal (9) the fine powder.

The photocatalyst obtained by precipitating titanium dioxide on a sol of manganese dioxide is shown in the flowchart of the synthesis employing TiOSO₄ given in FIG. 1. The hydrated manganese dioxide sol is obtained by mixing the required volumes of manganese acetate, i.e. Mn(CH₃COO)₂, 0.1 M—M indicates molarity—and potassium permanganate, i.e. KMnO₄, 0.1 M solutions and stirring the mixture for 12 to 36 hours at room temperature. In general, the concentration of manganese acetate and potassium permanganate may vary between 0.01 M to 4 M. The obtained sol is mixed with a solution of TiOSO₄. The quantity of TiOSO₄ is computed so the desired ratio between Mn and Ti is achieved. The quantity of water required for the preparation of the solution is computed so that the concentration of TiOSO₄ in the final solution is between 10⁻³-4×10⁻¹ M. The colloidal solution is stirred (1) at room temperature for a period between 24 to 68 hours, preferably around 48 hours, in order to obtain the adsorption equilibrium. During this phase an exchange of Mn with Ti occurs and the final sol is a mixture of both dioxides. After this the remaining Ti⁺⁴ ions are forced to precipitate by adding NH₃ solution so that the final pH is 7 (2). The gel that is obtained from the precipitation (2) is ageing by stirring (3) for a period between 24 to 68 hours, preferably around 48 hours. The gel is then separated (4) using a centrifuge or alternatively it is filtered under vacuum, to obtain powder. Thereafter the powder is washed (5) with distilled water until is free of sulfate and ammonium ions. The powder is free of sulfate and ammonium ions when the test of sulfate and ammonium is negative. If the test is positive, the procedure (5) is repeated. After washing, the powder, which is free of sulfate and ammonium ions, undergoes centrifugation or filtering (6) and then it is dried (7). The dried powder is broken into a fine powder (8) by grinding or milling. In order to increase the crystallinity of the photocatalyst annealing (9) is required. For these formulations the annealing temperature is between 200° C. and 900° C., preferably 700° C., for 1 to 10 hours. By this method we have made formulations with the atomic ratio Mn:Ti varying between 0.01:100 and 33:100. Scanning Electron Microscopy—SEM—and Transmission Electron Microscopy—TEM—revealed that the particle size of the photocatalyst is between 1 nm and 100 nm, with most frequent measurements being around 20 nm. FIG. 4 shows the size of the particles in the case of titanium dioxide photocatalyst doped with 1% MnO₂.

The photocatalytic activity was tasted both in liquid and gaseous phase. The photocatalyst was able to decompose methanol and acetaldehyde in gaseous phase, to accelerate the photo-oxidation of NO in gaseous phase—see FIG. 2, Mn:Ti 1:100—and to reduce methylene blue (MB) dye in aqueous solution—see FIG. 3. In particular FIG. 3 illustrates the degradation of methylene blue in photocatalytic materials with different doped concentrations of Manganese dioxide. The photocatalyst doped with 0.1% MnO₂ showed higher photocatalytic activity in the degradation of MB under visible light. In that case the photocatalyst was active both under UV—not shown in FIG. 3—and visible light exposure. The line indicated with MB in FIG. 3 shows the degradation of methylene blue without photocatalyst.

An example of the implementation of the method to obtain a photocatalytic material doped with manganese with 0.1% concentration is described below:

Typically to synthesize 0.1% MnO₂@TiO₂ we prepare a solution (thereafter solution A) of hydrated manganese dioxide sol. To make the solution A, we add to 600 ml of water, 3 ml of manganese acetate, i.e. Mn(CH₃COO)₂, having a concentration of 0.1 M and consequently 2 ml of potassium permanganate, i.e. KMnO₄, having a concentration of 0.1 M. The solution A is allowed to stir for 24 h at room temperature. At the same time, 140 g of the Ti-containing precursor of titanium (IV) oxysulfate hydrate, i.e. TiOSO₄xH₂O, is dissolved in 1.2 Lt of water under stirring for 2 h. Then, a 200 ml of ammonium hydroxide solution (25% NH₃) is added followed by vigorous stirred for 24 h to prepare titanium dioxide sol—thereafter solution B. In order to obtain the adsorption equilibrium solution A is added to solution B under vigorous stirring for 48 hours. The mixture is filtered and washed with distilled water until free of sulfate and ammonium ions, yielding a brownish-grey powder. The white precipitate is dried at 100° C. for 4 h and allowed for calcination at 700° C. for 2 h (heating rate=15° C./min). The synthetic steps are shown in FIG. 1. The powder was annealed at various temperatures and characterised using X-ray diffraction—see FIG. 5 and FIG. 6. The figures show powder X-ray Diffraction (XRD) patterns in different calcinations temperatures of 0.1% MnO₂ @ TiO₂. The sample in the range of calcination temperatures has predominantly the anatase phase. The crystallinity of the photocatalytic material can be correlated with the bulk defects. The bulk defects are the sites where electron-hole recombination occurs. Fewer lattice defects induce a decrease in the electron-hole recombination rate increasing the photocatalytic activity. For TiO₂ the lattice type is important because different crystalline phases have different photocatalytic activities, the anatase phase being the most active. Both scanning and transmission electron microscopy (SEM and TEM) confirm that the material is comprised of small irregular grains agglomerated together. The particles can be easily de-agglomerated by appropriate grinding. All the annealed powders have shown the same composition after annealing and the same granular structure.

1. A method to produce a photocatalyst comprising precipitating titanium dioxide on a sol of manganese dioxide, by providing a mixture including a) hydrated manganese dioxide sol, b) titanium solution and c) NH₃ solution.

2. The method according to claim 1, wherein the titanium solution is an aqua solution of titanium oxysulfate.

3. The method according to claim 1, wherein the pH of the mixture is in the range of 6 to 8.

4. The method according to claim 1, wherein the pH of the mixture is about 7.

5. The method according to claim 1, wherein the mixture is processed to obtain a powder including titanium dioxide and manganese dioxide and the powder is filtered and washed with distilled water.

6. The method according to claim 1, wherein the mixture is processed to obtain a powder including titanium dioxide and manganese dioxide and the powder is annealed at a temperature in the range of 600° C. to 900° C.

7. The method according to claim 1, wherein the mixture is processed to obtain a powder including titanium dioxide and manganese dioxide and the powder is annealed at a temperature about 700° C.

8. The method according to claim 1, wherein the mixture is processed to obtain a powder and the powder is processed by milling or grinding.

9. The method according to claim 1, further comprising:
a) providing a colloidal solution containing hydrated manganese dioxide sol and titanium solution;
b) stirring the colloidal solution;
c) adding NH₃ solution to obtain a gel;
d) maturing the gel by stirring;
e) separating the gel using a centrifuge or by filtering to obtain powder;
f) washing the powder;
g) centrifuging or filtering the powder;
h) drying the gel to obtain a dried product;
i) breaking the dried product until is broken into a fine powder by grinding or milling;
j) annealing the fine powder.

10. A photocatalyst produced by the method according to claim 1, comprising particles with a size of in the range 1 nm to 100 nm.

11. A photo catalyst produced by the method according to claim 1, comprising particles with a size of about 20 nm.

12. A photocatalyst produced by the method according to claim 1, wherein the photo catalyst predominantly comprises the anatase crystalline structure.

13. A photocatalyst produced by the method according to claim 1 consisting of powder including titanium dioxide and manganese dioxide formulations with the atomic ratio Mn:Ti varying in the range of 0.01:100 to 33:100.

14. A photocatalyst produced by the method according to claim 1 comprising powder including titanium dioxide and manganese dioxide formulations with the atomic ratio Mn:Ti varying in the range of 0.01:100 to 33:100.

15. The method according to claim 2, wherein the pH of the mixture is in the range of 6 to 8.

16. The method according to claim 2, wherein the mixture is processed to obtain a powder including titanium dioxide and manganese dioxide and the powder is filtered and washed with distilled water.

17. The method according to claim 3, wherein the mixture is processed to obtain a powder including titanium dioxide and manganese dioxide and the powder is filtered and washed with distilled water.

18. The method according to claim 2, wherein the mixture is processed to obtain a powder including titanium dioxide and manganese dioxide and the powder is annealed at a temperature in the range of 600° C. to 900° C.

19. The method according to claim 3, wherein the mixture is processed to obtain a powder including titanium dioxide and manganese dioxide and the powder is annealed at a temperature in the range of 600° C. to 900° C.

20. The method according to claim 2, wherein the mixture is processed to obtain a powder and the powder is processed by milling or grinding.
